(19) United States
(12) Patent Application Publication
(10) Pub. No.: US 2005/0274598 A1
(43) Pub. Date: Dec. 15, 2005

(54) Vacuum sealing arrangement for a liquid concentrator

(75) Inventor: John David Forsyth, Tuakau (NZ)

Correspondence Address: BIRCH STEWART KOLASCH & BIRCH, PO BOX 747, FALLS CHURCH, VA, 22040-0747, US

(73) Assignee: Distech Limited, Auckland (NZ)

(21) Appl. No.: 10/522,064

(22) PCT Filed: Jul. 23, 2003
(86) PCT No.: PCT/NZ03/00160

§ 371 Date: Jul. 6, 2005

(30) Foreign Application Priority Data
Jul. 24, 2002 (NZ) 520365

(51) Int. Cl. B01D 3/10; B01D 3/08; B01D 1/28

(52) U.S. Cl. 203/91; 202/205; 202/182; 202/238; 203/24; 159/DIG. 16; 159/6.1; 159/24.1; 203/26

(57) ABSTRACT

The liquid concentrator has a vacuum vessel or chamber (1) in which a required vacuum is established. Within the common vessel or chamber (1) are provided concentrator components including a feed section (2), an evaporation plus condensing/section (3), a separation area (4), a baffle arrangement (5) and a vapour compressor (6). A seal (8) may be provided for the connection between the compressor (6) and a motor (7) mounted externally of the vessel or chamber (1). In another embodiment the motor (7) may also be mounted within the vessel or chamber (1). The invention avoids the cost and complexity of providing separate vacuum seals for each of the concentrator components.

### FIELD OF INVENTION

The present invention relates to improvements in and relating to a vacuum sealing arrangement for a liquid concentrator and a liquid concentrator with such vacuum sealing.

### BACKGROUND OF INVENTION

Liquid concentrators are used in numerous types of industries. In New Zealand a major use is in respect of the concentration of milk so as to achieve a more cost effective transportation of the milk.

It is to be understood, however, that the present invention has application throughout the area of liquid concentrators no matter what their intended use may be.

A significant problem with existing liquid concentrators is in respect of the maintaining of the vacuum within the various concentrator componentry. Typically this problem presents itself at the seals required for the external ducting between the various concentrator components. In liquid concentrators, by evaporating the liquid in a partial vacuum, concentration can be effected at lower than normal temperatures thus reducing damage to the liquid and possible damage to the materials used in the construction of the concentrator. By utilizing methods of vapour recompression, the latent heat of condensation can be used to create the evaporation process and can provide substantial energy savings. In concentrators operating under partial vacuum, extensive engineering is required to ensure the structural strength and vacuum requirements are achieved. In one example of a typical concentrator used in the concentration of milk, the concentrator would be operating at temperatures of the order of 75° C. and at 0.3 bar partial vacuum.

There is therefore in current concentrators the cost and complexity of maintaining the vacuum seals between the various concentrator components.

Although the present invention has particular use in liquid concentrators, it will be apparent to those skilled in the engineering arts that the present invention may have applications throughout the design of any other apparatus which incorporates a plurality of interconnected components all or some of which are required to operate under a vacuum. The term “concentrator” as used in the present specification is therefore to be understood to cover all such apparatus.

### OBJECTS OF THE INVENTION

It is thus an object of the present invention in one embodiment thereof to provide a liquid concentrator which overcomes or at least ameliorates problems with such liquid concentrators available to the present time and/or which at least will provide the public with a useful choice.

Further objects of this invention may be become apparent from the description.

### SUMMARY OF THE INVENTION

According to one aspect of the present invention there is provided a liquid concentrator having a plurality of components required to operate in use under vacuum and wherein said components are adapted to be provided within a common vacuum vessel or chamber and within which a required vacuum can, in use, be established, said components including a feed section for receiving the liquid to be concentrated, an evaporation/condensing section to produce concentrated liquid and vapour, a separation means to separate the concentrated liquid from the vapour and a vapour compression means, all accommodated within the vacuum vessel or chamber.

According to a further aspect of the present invention there is provided a method of constructing a liquid concentrator having a plurality of components each required to operate under a vacuum, said method including providing said components with a common vacuum vessel or chamber and adapting said vacuum vessel or chamber to have a required vacuum established therein, said components provided within the vacuum vessel or chamber including a feed section and an evaporation/condensing section having a separation area to separate concentrated liquid and vapour and a vapour compression means.

According to a still further aspect of the present invention a liquid concentrator and/or a method of constructing a liquid concentrator is/are substantially as herein described with reference to the accompanying drawing.

Further aspects of this invention which shall be considered in all its novel aspects will become apparent from the following description given by way of example of possible embodiments thereof and in reference is made to the accompanying drawings.

### BRIEF DESCRIPTION OF THE DRAWINGS

FIG. 1: Shows very diagrammatically a liquid concentrator according to one possible embodiment of the invention.

FIG. 2: Shows in greater detail the concentrator of FIG. 1.

FIG. 3: Shows diagrammatically a liquid concentrator according to a further possible embodiment of the invention.

### DESCRIPTION OF THE PREFERRED EMBODIMENT OF THE INVENTION

As mentioned previously a liquid concentrator is an example of an apparatus which has a plurality of inter-connected components each of which is required to operate under a vacuum.

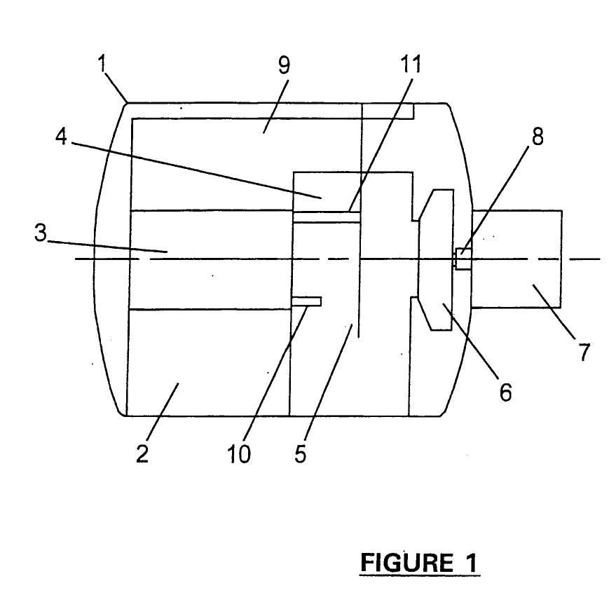

In FIG. 1 a very diagrammatic cross-sectional view of a concentrator is shown in which the various components of the concentrator are arranged within a common enclosure 1 and within which a required vacuum will in use be established and maintained. The enclosure 1, which may be any suitable vacuum vessel or chamber, will be provided with appropriate vacuum establishing means of any suitable type and as will be well known to those skilled in the engineering arts.

In the particular embodiment shown a liquid to be concentrated is fed into a feed section 2 and then into an evaporation/condensing section 3.

Where the concentrator is to be used in respect of food products such as milk a stainless steel enclosure 1 may typically be used.

Typically the liquid will be boiled at a reduced temperature within the evaporation/condensing section 3 in producing concentrated liquid and steam. The mixture of the concentrated liquid and steam will then pass through a separation area 4 and a baffle arrangement 5 where the concentrated liquid is separated from the vapour.

The vapour will then pass through a vapour compressor 6 driven by a motor 7. A seal 8 is suitably provided for the shaft connecting the motor 7 of the compressor 6 in retaining the vacuum within the vessel 1.

Compressed steam may then suitably be fed through a return duct 9 to the evaporation/condensing section 3 where the latent heat of the steam will be given off to boil the incoming liquid. This action will result in the condensation of the steam to pure water which can be extracted from the vessel 1 through a pipe connection 10. Any non-condensable gasses may be recycled through connection 11 for subsequent discharge through the system that provides the vacuum to the vessel 1.

It will be seen that by arranging all the major components of the concentrator fully within a common closure such as a vacuum vessel 1, the design requirements for vacuum, strength and integrity for those components is minimised to be only those of the vessel 1 and the connections. In FIG. 1 it is only the motor 7 which is outside the vessel 1.

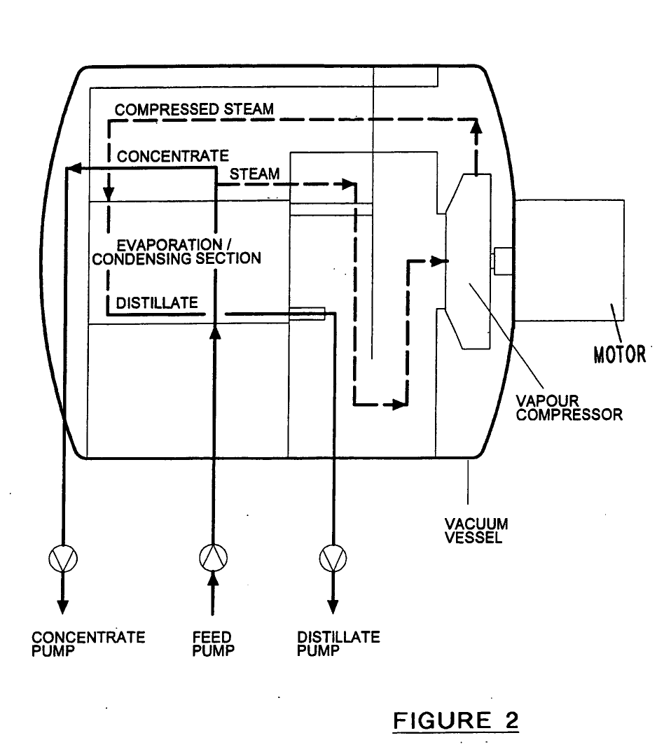

Referring to FIG. 2, the embodiment of FIG. 1 is shown in greater detail in showing the flow paths of the incoming feed liquid and the outgoing concentrate and distillate, and the flow paths within the separator components accommodated within the vacuum vessel.

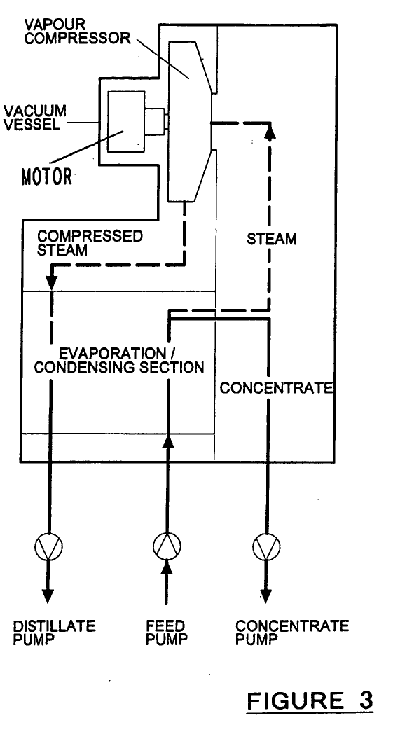

Referring to FIG. 3, an alternative embodiment may typically operate at a lower pressure and with lower temperatures. In this embodiment it is seen that now the motor has also been accommodated within the vacuum vessel so that vacuum sealing between the motor and the vapour compressor is not needed.

Typical values of operating pressure and temperature for the embodiments of FIGS. 2 and 3 may be as follows:

| | Feed | Concentrate | Distillate | Compressed |
|---|---|---|---|---|
| | Temperature | Temperature | Temperature | Steam Pressure |
| FIG. 2: | 72° C. | 72° C. | 75° C. | .37 bar (absolute) |
| | | | | (37 kPA) |
| FIG. 3: | 62° C. | 62° C. | 65° C. | .27 bar (absolute) |
| | | | | (27 kPA) |

As mentioned previously, although this invention has been described particularly with respect to the various components of a liquid concentrator it will be understood by those skilled in the engineering arts that the present invention could have application in respect of any design of apparatus having multiple components which are required to operate under a vacuum and in which according to the present invention the cost and complexity of providing the vacuum can be reduced by providing the components within a common vacuum enclosure or vessel.

Where in the foregoing description, reference has been made to specific components or integers having known equivalents, then such equivalents are incorporated herein as if individually set forth.

Although the above description has been given by way of example with reference to possible embodiments of the invention, it is to be understood that modifications or improvements may be made without departing from the scope of the invention as defined in the appended claims.

1. A liquid concentrator having a plurality of components required to operate in use under vacuum and wherein said components are adapted to be provided within a common vacuum vessel or chamber and within which a required vacuum can, in use, be established, said components including a feed section for receiving the liquid to be concentrated, an evaporation/condensing section to produce concentrated liquid and vapour, a separation means to separate the concentrated liquid from the vapour and a vapour compression means, all accommodated within the vacuum vessel or chamber.

2. A liquid concentrator as claimed in claim 1 wherein a drive means for the said vapour compression means is provided outside said vacuum vessel or chamber and a sealing means provided about a shaft of the compression means to enable its entry into the vacuum vessel or chamber and its connection, to drive, said vapour compression means.

3. A liquid compressor as claimed in claim 1 where a drive means for the said vapour compression means is also provided within said vacuum vessel or chamber.

4. A liquid concentrator as claimed in claim 1 in which the vapour compression means produces compressed steam pressurised between about 0.2 bar (a) to 0.4 bar (a) and temperatures of the feed liquid and concentrate are between about 60° C. to 70° C.

5. (canceled)

6. A method of constructing a liquid concentrator having a plurality of components each required to operate under a vacuum, said method including providing said components with a common vacuum vessel or chamber and adapting said vacuum vessel or chamber to have a required vacuum established therein, said components provided within the vacuum vessel or chamber including a feed section and an evaporation/condensing section having a separation area to separate concentrated liquid and vapour and a vapour compression means.

7. A method as claimed in claim 6 in which said components included within the vacuum vessel or chamber include a drive means for said vapour compression means.

8. (canceled)
